(19) United States
(12) Patent Application Publication
(10) Pub. No.: US 2014/0184939 A1
(43) Pub. Date: Jul. 3, 2014

(54) TOUCH STRUCTURE

(71) Applicant: Novatek Microelectronics Corp., Hsinchu (TW)

(72) Inventors: Chih-Chang LAI, Taichung City (TW); Chi-Te LIN, Hsinchu County (TW); Tien-Nan WANG, Taichung City (TW); He-Wei HUANG, Hsinchu City (TW); Yu-Sheng LAI, Hsinchu County (TW)

(73) Assignee: Novatek Microelectronics Corp., Hsinchu (TW)

(21) Appl. No.: 13/943,831

(22) Filed: Jul. 17, 2013

(30) Foreign Application Priority Data
Jan. 3, 2013 (TW) 102100148

(51) Int. Cl. G06F 1/16

(52) U.S. Cl. CPC G06F 1/1692
USPC 349/12

(57) ABSTRACT

A touch structure is provided. The touch structure includes a first sensing electrode, a second sensing electrode, a first dummy pattern and a second dummy pattern. The first sensing electrode and the second sensing electrode are arranged in a staggered manner and electrically insulated from each other. The first dummy pattern is adjacent to the first sensing electrode and has a first pattern acute angle. The second dummy pattern is adjacent to the second sensing electrode and has a second pattern acute angle. The first dummy pattern and the second dummy pattern are separated from each other. The first pattern acute angle and the second pattern acute angle are faced toward the same overlapped portion between the first sensing electrode and the second sensing electrode substantially.

This application claims the benefit of Taiwan application Serial No. 102100148, filed Jan. 3, 2013, the subject matter of which is incorporated herein by reference.

### BACKGROUND OF THE INVENTION

1. Field of the Invention

The invention relates in general to a touch structure, and more particularly to a touch structure of a capacitive touch panel.

2. Description of the Related Art

Touch panel has been widely used in various fields such as home appliances, telecommunication devices and electronic devices. The touch panel allows a user to input control signals by clicking or touching the touch panel with a finger or a stylus. As consumers are expecting higher and higher quality standards of the touch panel, the operating efficiency of the touch panel also needs to be increased to meet the market demand.

### SUMMARY OF THE INVENTION

The invention is directed to a touch structure capable enhancing the operating efficiency of the touch panel.

A touch structure is provided. The touch structure comprises a first sensing electrode, a second sensing electrode, a first dummy pattern and a second dummy pattern. The first sensing electrode and the second sensing electrode are arranged in a staggered manner and electrically insulated from each other. The first dummy pattern is adjacent to the first sensing electrode and has a first pattern acute angle. The second dummy pattern is adjacent to the second sensing electrode and has a second pattern acute angle. The first dummy pattern and the second dummy pattern are separated from each other. The first pattern acute angle and the second pattern acute angle substantially face toward the same overlapped portion between the first sensing electrode and the second sensing electrode.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a touch structure according to one embodiment;

FIG. 2 shows a schematic diagram of a touch structure according to one embodiment;

FIG. 3 shows a schematic diagram of a touch structure according to one embodiment;

FIG. 4 shows a schematic diagram of a touch structure according to one embodiment;

FIG. 5 shows a schematic diagram of a touch structure according to one embodiment.

### DETAILED DESCRIPTION OF THE INVENTION

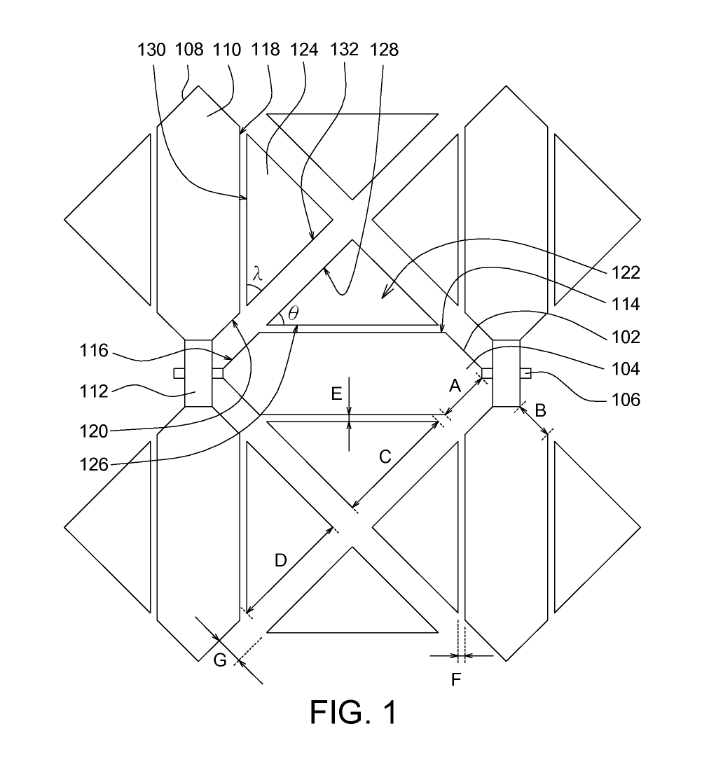

FIG. 1 shows a schematic diagram of a touch structure according to one embodiment. For example, the touch panel may be a capacitive touch panel. The first sensing electrode 102 comprises a first electrode pattern portion 104 and a first electrode bridge portion 106 coupled to the first electrode pattern portion 104. The second sensing electrode 108 comprises a second electrode pattern portion 110 and a second electrode bridge portion 112 coupled to the second electrode pattern portion 110. The first sensing electrode 102 and the second sensing electrode 108 are arranged in a staggered manner through the first electrode bridge portion 106 and the second electrode bridge portion 112. In embodiments, the first sensing electrode 102 and the second sensing electrode 108 are electrically insulated from each other by an insulating layer (not illustrated) disposed between the first electrode bridge portion 106 and the second electrode bridge portion 112. The first electrode bridge portion 106 and the second electrode bridge portion 112 are not limited to a rectangle shape such as a long strip shape as shown in FIG. 1, and may have other suitable shapes.

The first sensing electrode 102 comprising the first electrode pattern portion 104 and the first electrode bridge portion 106 and the second sensing electrode 108 comprising the second electrode pattern portion 110 and the second electrode bridge portion 112 may be formed by a conductive material such as a transparent material comprising indium tin oxide (ITO), aluminum and zinc oxide (AZO), etc. The first sensing electrode 102 may be extended in a horizontal direction (such as X direction) with repetitive structure units (defined by the first electrode pattern portion 104 and the first electrode bridge portion 106, for example). The second sensing electrode 112 may be extended in a longitudinal direction (such as Y direction substantially perpendicular to the X direction) with repetitive structure units (defined by the second electrode pattern portion 110 and the second electrode bridge portion 112, for example). The first sensing electrode 102 and the second sensing electrode 108 may be formed on a substrate (not illustrated). The substrate may be formed by a transparent material such as a transparent glass. In one embodiment, the first sensing electrode 102 and the second sensing electrode 108 have the same area, such that the first sensing electrode 102 and the second sensing electrode 108 can be arbitrarily switched to functions of driving or receiving, increasing the operation flexibility.

Referring to FIG. 1, the first electrode pattern portion 104 has a first electrode side 114 and a third electrode side 116 adjoined to the first electrode side 114. The third electrode side 116 is adjoined to the first electrode bridge portion 106. The first electrode side 114 may be adjoined between two the third electrode sides 116. The second electrode pattern portion 110 has a second electrode side 118 and a fourth electrode side 120 adjoined to the second electrode side 118. The fourth electrode side 120 is adjoined to the second electrode bridge portion 112. The second electrode side 118 may be adjoined between two the fourth electrode sides 120.

Referring to FIG. 1, in one embodiment, the first electrode pattern portion 104 and the second electrode pattern portion 110 have a hexagon shape such as a symmetric hexagon shape. For example, a length of the first electrode side 114 of the first electrode pattern portion 104 may be larger than a length of the third electrode side 116. The opposing first electrode sides 114 may be substantially parallel to each other, and have the same length. The opposing third electrode sides 116 may be substantially parallel to each other, and have the same length. A length of the second electrode side 118 of the second electrode pattern portion 110 may be larger than a length of the fourth electrode side 120. The opposing second electrode sides 118 may be substantially parallel to each other, and have the same length. The opposing fourth electrode sides 120 may be substantially parallel to each other, and all the fourth electrode sides 120 may have the same length.

The first electrode pattern portion 104 and the second electrode pattern portion 110 are not limited to the hexagon shape indicated in FIG. 1, and may have other suitable shapes, such as a rhombus shape, a rectangle shape, a triangle shape, or other polygons shapes. The first electrode pattern portion 104 is not limited to the symmetric shape indicated in FIG. 1, such as a left-right mirror structure symmetric with respect to a virtual orthogonal line defined at the central point of the first electrode side 114. The first electrode pattern portion 104 may have an asymmetric structure. The second electrode pattern portion 110 is not limited to the symmetric shape indicated in FIG. 1, such as a top-down mirror structure symmetric with respect to a virtual orthogonal line defined at the central point of the second electrode side 118. The second electrode pattern portion 110 may have an asymmetric structure. In some embodiment, the first electrode pattern portion 104 and the second electrode pattern portion 110 have the same area, such that the first electrode pattern portion 104 and the second electrode pattern portion 110 can be arbitrarily switched to functions of driving or receiving, increasing the operation flexibility. In some embodiments, in comparison to the diamond-shaped first electrode pattern portion 104 and second electrode pattern portion 110, the hexagonal first electrode pattern portion 104 and second electrode pattern portion 110 of FIG. 1 have better performance in reducing the noises sensed during the operation of the capacitive touch panel and increasing the input signals for increasing the signal noise ratio.

Referring to FIG. 1, the first dummy pattern 122 and the second dummy pattern 124 are separated from each other, and separated and insulated from the first sensing electrode 102 and the second sensing electrode 108 by an insulating material, for example. For example, the first dummy pattern 122 and the second dummy pattern 124 may be formed by a transparent conductive material such as indium tin oxide (ITO), aluminum and zinc oxide (AZO), etc. The first dummy pattern 122 and the second dummy pattern 124 may be not electrically connected to any electrodes or conductive wires, or may grounded, or may be electrically connected to any given fixed reference electrode or floating electrode. Similar concepts are not repeated hereinafter.

The first dummy pattern 122 is adjacent to the first electrode pattern 104 of the first sensing electrode 102. The first dummy pattern 122 has a first dummy side 126 and a third dummy side 128 adjoined to each other, and a first pattern acute angle θ is included between the first dummy side 126 and the third dummy side 128. The second dummy pattern 124 is adjacent to the second electrode pattern 110 of the second sensing electrode 108. The second dummy pattern 124 has a second dummy side 130 and a fourth dummy side 132 adjoined to each other, and a second pattern acute angle λ is included between the second dummy side 130 and the fourth dummy side 132. The first pattern acute angle θ and the second pattern acute angle λ substantially face toward the same overlapped portion between the first sensing electrode 102 and the second sensing electrode 108.

Referring to FIG. 1, for example, the first dummy side 126 may be substantially parallel to the first electrode side 114 adjacent to the first dummy side 126. The second dummy side 130 may be substantially parallel to the second electrode side 118 adjacent to the second dummy side 130. The third dummy side 128 and the fourth dummy side 132 adjacent to each other may be substantially parallel to each other. The third dummy side 128 may be substantially parallel to the third electrode side 116. The fourth dummy side 132 is substantially parallel to the fourth electrode side 120.

Referring to FIG. 1, in the embodiment, the first dummy pattern 122 and the second dummy pattern 124 have triangle shapes such as isosceles triangle shapes. For example, a length of the first dummy side 126 may be larger than a length of the third dummy side 128. A right angle, an obtuse angle or an acute angle may be included between the two adjacent third dummy sides 128 having the same length. The length of the second dummy side 130 may be larger than the length of the fourth dummy side 132. A right angle, an obtuse angle or an acute angle may be included between the two adjacent fourth dummy sides 132 having the same length.

In one embodiment, for example, the length A of the third electrode side 116 of the first electrode pattern portion 104 is 3 mm. The length B of the fourth electrode side 120 of the second electrode pattern portion 110 is 3 mm. The length C of the third dummy side 128 of the first dummy pattern 122 is 3 mm. The length D of the fourth dummy side 132 of the second dummy pattern 124 is 3 mm. The gap distance E between the first electrode side 114 and the first dummy side 126 is 20 μm. The gap distance F between the second electrode side 118 and the second dummy side 130 is 20 μm. The gap distance G between the third dummy side 128 and the fourth dummy side 132 is 20 μm. In other embodiments, the size can also be adjusted according to actual needs.

In other embodiments, the first dummy pattern 122 and the second dummy pattern 124 may comprise other suitable shapes, such as a right triangle shape, an equilateral triangle shape, or other polygons shapes. Moreover, the first dummy pattern 122 is not limited to the symmetric shape indicated in FIG. 1, such as a left-right mirror structure symmetric with respect to a virtual orthogonal line defined at the central point of the first dummy side 126. The first dummy pattern 122 may have an asymmetric structure. The second dummy pattern 124 is not limited to the symmetric shape indicated in FIG. 1, such as a top-down mirror structure symmetric with respect to a virtual orthogonal line defined at the central point of the second dummy side 130. The second dummy pattern 124 may have an asymmetric structure. In one embodiment, the size and shape of each of the first dummy pattern 122 and the second dummy pattern 124 may be the same or different.

A touch unit can be defined by a region formed by the two adjacent (top and down) first electrode patterns and the two adjacent (left and right) second electrode patterns. Referring to the example of FIG. 1, in a single touch unit, a single first dummy pattern 122 corresponds to a single first electrode pattern portion 104, and a single second dummy pattern 124 corresponds to a single second electrode pattern portion 110. That is, the single touch unit has the two first dummy patterns 122 and the two second dummy patterns 124. However, the present disclosure is not limited thereto. In other embodiments, the single touch unit may have the first dummy pattern 122 and the second dummy pattern 124 with other quantities, shapes and disposition methods.

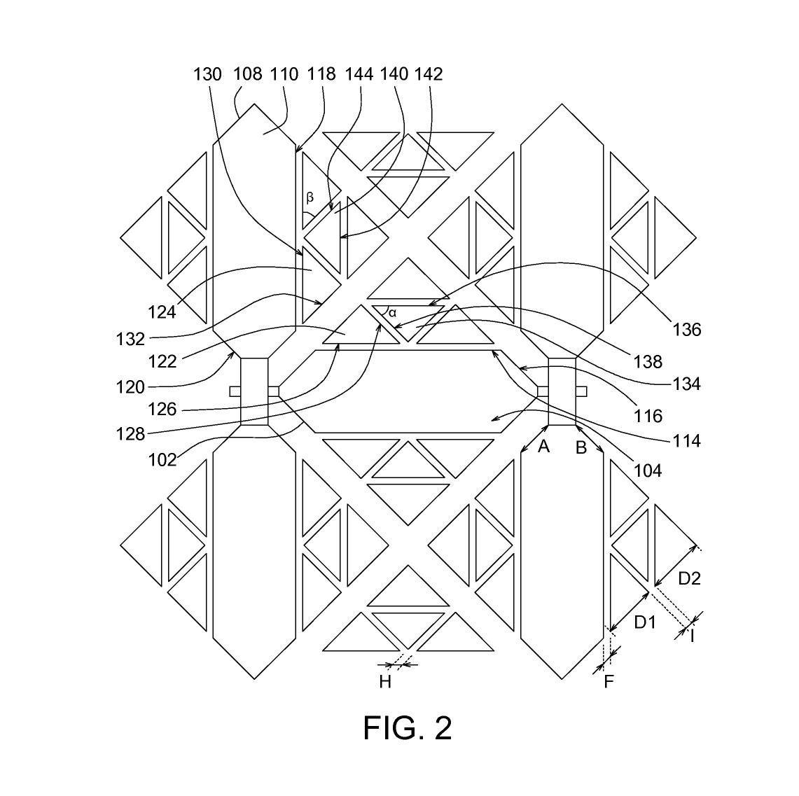

The touch structure of FIG. 2 is different from the touch structure of FIG. 1 in that the third dummy pattern 134 adjacent to the first electrode side 114 of the first sensing electrode 102 is disposed among the three first dummy patterns 122. The third dummy pattern 134 has a fifth dummy side 136 and a seventh dummy side 138 adjoined to each other, and a third pattern acute angle α is included between the fifth dummy side 136 and the seventh dummy side 138. The fifth dummy side 136 is adjoined between the two seventh dummy sides 138. For example, the fifth dummy side 136 may be substantially parallel to the first electrode side 114 of the first sensing electrode 102 or the first dummy side 126 of the first dummy pattern 122. The seventh dummy side 138 may be substantially parallel to the third dummy side 128 of the first dummy pattern 122 adjacent to the seventh dummy side 138.

Referring to FIG. 2, the fourth dummy pattern 140 adjacent to the second electrode side 118 of the second sensing electrode 108 is disposed among the three second dummy patterns 124. The fourth dummy pattern 140 has a sixth dummy side 142 and an eighth dummy side 144 adjoined to each other, and a fourth pattern acute angle β is included between the sixth dummy side 142 and the eighth dummy side 144. The sixth dummy side 142 is adjoined between the two eighth dummy sides 144. The sixth dummy side 142 may be substantially parallel to the second electrode side 118 of the second sensing electrode 108 or the second dummy side 130 of the second dummy pattern 124. The eighth dummy side 144 may be substantially parallel to the fourth dummy side 132 of the second dummy patterns 124 adjacent to the eighth dummy side 144.

In one embodiment, the size and shape of each of the first dummy pattern 122, the second dummy pattern 124, the third dummy pattern 134, the fourth dummy pattern 140 may be the same or different.

In one embodiment, the length A of the third electrode side 116 of the first electrode pattern portion 104 is 2 mm. The length B of the fourth electrode side 120 of the second electrode pattern portion 110 is 2 mm. What correspond to the single second electrode pattern portion 110 are the three second dummy pattern 124, wherein the length D1 of the fourth dummy side 132 of the second dummy pattern 124 closer to the second electrode pattern portion 110 is 1.5 mm, and the length D2 of the fourth dummy side 132 of the second dummy pattern 124 farther away from the second electrode pattern portion 110 is 2.5 mm. The gap distance F between the second electrode side 118 and the second dummy side 130 is 20 μm. The gap distance H between the third dummy side 128 and the seventh dummy side 138 is 20 μm. The gap distance I between the first electrode side 114 and the fourth dummy side 132 is 20 μm. In other embodiments, the size may be adjusted according to actual needs.

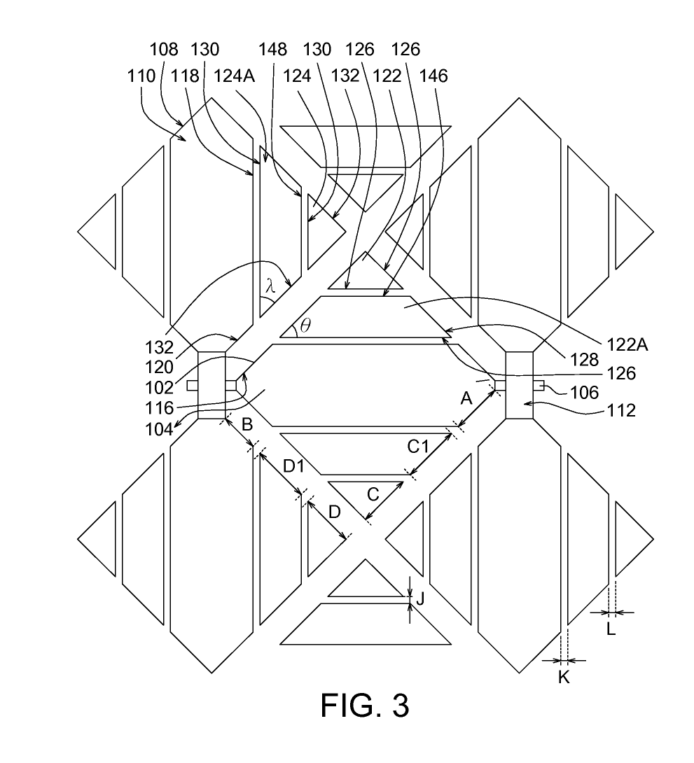

The touch structure of FIG. 3 is different from the touch structure of FIG. 1 in that the first dummy pattern 122A close to the first electrode pattern portion 104 is has a quadrilateral shape, and a first pattern acute angle θ included between the first dummy side 126 and the third dummy side 128. The first dummy side 126 is adjoined between the two third dummy sides 128. The ninth dummy side 146 of the first dummy pattern 122A is adjoined between the two third dummy sides 128. The quadrilateral first dummy pattern 122A is closer to the first electrode pattern portion 104 of the first sensing electrode 102 than the triangular first dummy pattern 122. The first dummy pattern 122A is not limited to the trapezoid shape such as an equilateral trapezoid shape indicated in FIG. 3, and may have other suitable symmetric or asymmetric quadrilaterals shapes.

Referring to FIG. 3, the second dummy pattern 124A close to the second electrode pattern portion 110 has a quadrilateral shape, and a second pattern acute angle λ is included between the second dummy side 130 and the fourth dummy side 132. The second dummy side 130 is adjoined between the two opposing fourth dummy sides 132. The tenth dummy side 148 of the second dummy pattern 124A is adjoined between the two opposing fourth dummy sides 132. The quadrilateral second dummy pattern 124A is closer to the second electrode pattern portion 110 of the second sensing electrode 108 than the triangular second dummy pattern 124. The second dummy pattern 124A is not limited to the trapezoid shape such as an equilateral trapezoid shape indicated in FIG. 3, and may have other suitable symmetric or asymmetric quadrilaterals shapes.

In one embodiment, the size and shape of each of the first dummy pattern 122, 122A, the second dummy pattern 124, 124A may be the same or different.

In one embodiment, the length A of the third electrode side 116 of the first electrode pattern portion 104 is 1.7 mm. The length B of the fourth electrode side 120 of the second electrode pattern portion 110 is 1.7 mm. The length C of the third dummy side 128 of the first dummy pattern 122 is 1.7 mm. The length Cl of the third dummy side 128 of the first dummy pattern 122A is 1.7 mm. The length D of the fourth dummy side 132 of the second dummy pattern 124 is 1.7 mm. The length D1 of the fourth dummy side 132 of the second dummy pattern 124A is 1.7 mm. The gap distance J between the first dummy side 126 of the first dummy pattern 122 and the ninth dummy side 146 of the first dummy pattern 122A is 20 μm. The gap distance K between the second electrode side 118 of the second electrode pattern portion 110 and the second dummy side 130 of the second dummy pattern 124A is 20 μm. The gap distance L between the tenth dummy side 148 of the second dummy pattern 124A and the second dummy side 130 of the second dummy pattern 124 is 20 μm. In other embodiments, the size can also be adjusted according to actual needs.

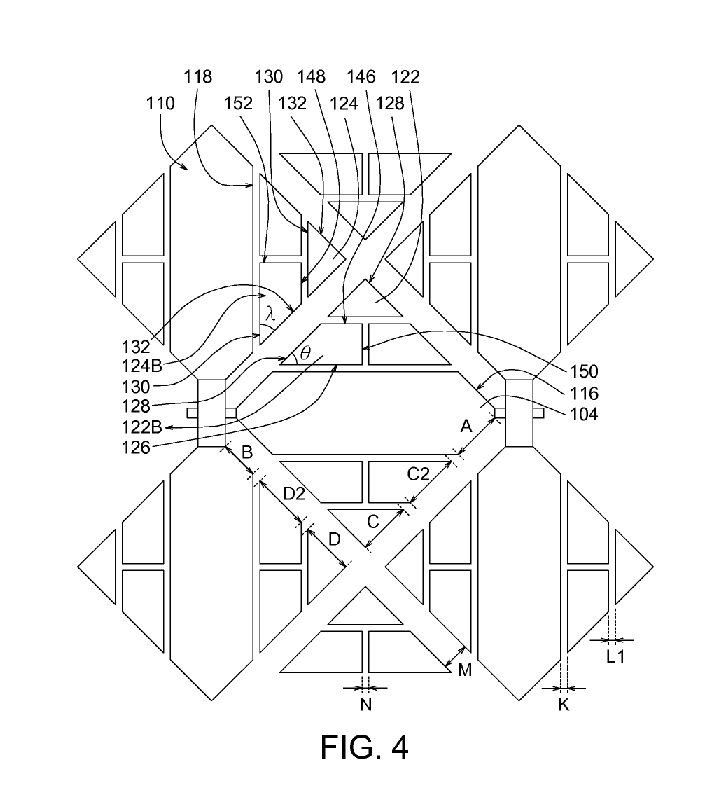

The touch structure of FIG. 4 is different from the touch structure of FIG. 3 in that the two first dummy patterns 122B close to the first electrode pattern portion 104 have quadrilateral shapes, and the first pattern acute angle θ is included between the first dummy side 126 and the third dummy side 128. The eleventh dummy side 150 of the first dummy pattern 122B is adjoined between the ninth dummy side 146 and the first dummy side 126, and may be substantially perpendicular to the ninth dummy side 146 and the first dummy side 126. Moreover, the two second dummy patterns 124B close to the second electrode pattern portion 110 have quadrilateral shapes, and the second pattern acute angle λ is included between the second dummy side 130 and the fourth dummy side 132 of the second dummy patterns 124B. The twelfth dummy side 152 of the second dummy pattern 124 is adjoined between the second dummy side 130 and the tenth dummy side 148, and may be substantially perpendicular to the second dummy side 130 and the tenth dummy side 148.

In one embodiment, the size and shape of each of the first dummy patterns 122 and 122B and the second dummy patterns 124 and 124B may be the same or different.

In one embodiment, for example, the length A of the third electrode side 116 of the first electrode pattern portion 104 is 2 mm. The length B of the fourth electrode side 120 of the second electrode pattern portion 110 is 2 mm. The length C of the third dummy side 128 of the first dummy pattern 122 is 2 mm. The length C2 of the third dummy side 128 of the first dummy pattern 122B is 2 mm. The length D of the fourth dummy side 132 of the second dummy pattern 124 is 2 mm. The length D2 of the fourth dummy side 132 of the second dummy pattern 124B is 2 mm. The gap distance K between the second electrode side 118 of the second electrode pattern portion 110 and the second dummy side 130 of the second dummy pattern 124B is 30 μm. The gap distance L1 between the tenth dummy side 148 of the second dummy pattern 124B and the second dummy side 130 of the second dummy pattern 124 is 30 μm. The gap distance M between the third dummy side 128 of the first dummy pattern 122 and the fourth dummy side 132 of the second dummy pattern 124 is 30 μm. The gap distance N between the adjacent eleventh dummy sides 150 of the first dummy pattern 122 is 30 μm. In other embodiments, the size may be adjusted according to actual needs.

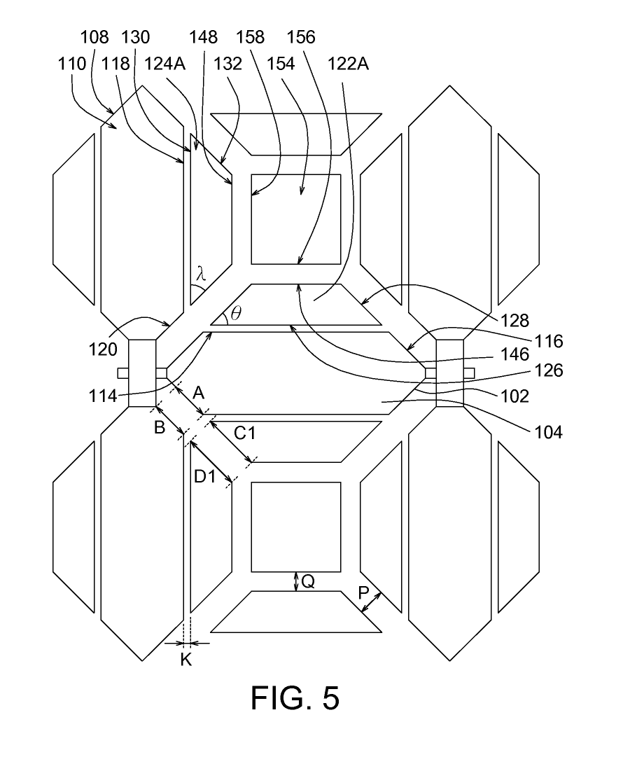

The touch structure of FIG. 5 is different from the touch structure of FIG. 3 in that the rectangular dummy pattern 154 is disposed adjacent to the first dummy pattern 122A and the second dummy pattern 124A. The thirteenth dummy side 156 of the rectangular dummy pattern 154 may be substantially parallel to the first dummy side 126 and the ninth dummy side 146 of the first dummy pattern 122A or the first electrode side 114 of the first electrode pattern portion 104. The fourteenth dummy side 158 of the rectangular dummy pattern 154 may be substantially parallel to the second dummy side 130 and the tenth dummy side 148 of the first dummy pattern 122A or the second electrode side 118 of the second electrode pattern portion 110. The first dummy pattern 122A is closer to the first sensing electrode 102 than the rectangular dummy pattern 154. The second dummy pattern 124A is closer to the second sensing electrode 108 than the rectangular dummy pattern 154. The rectangular dummy pattern 154 is not limited to the square shape indicated in FIG. 5, and may have other suitable shapes, such as a symmetric quadrilateral shape, an asymmetric quadrilateral shape or other polygons shapes. The quantity of rectangular dummy patterns 154 used in a single touch unit is not limited to one, and other suitable numbers can also be used.

In one embodiment, the size and shape of each of the rectangular dummy pattern 154, the first dummy pattern 122A, and the second dummy pattern 124A may be the same or different.

In one embodiment, the length A of the third electrode side 116 of the first electrode pattern portion 104 is 2 mm. The length B of the fourth electrode side 120 of the second electrode pattern portion 110 is 2 mm. The length C1 of the third dummy side 128 of the first dummy pattern 122A is 2 mm. The length D1 of the fourth dummy side 132 of the second dummy pattern 124A is 2 mm. The gap distance K between the second electrode side 118 of the second electrode pattern portion 110 and the second dummy side 130 of the second dummy pattern 124A is 30 μm. The gap distance P between the third dummy side 128 of the first dummy pattern 122A and the fourth dummy side 132 of the second dummy pattern 124A is 30 μm. The gap distance Q between the thirteenth dummy side 156 of the rectangular dummy pattern 154 and the ninth dummy side 146 of the first dummy pattern 122A is 30 μm. In other embodiments, the size can also be adjusted according to actual needs.

The touch structure can be used in a touch panel such as a capacitive touch panel. The touch structure and the touch panel based on the design of the above embodiment have excellent operating efficiency.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch structure, comprising:
a first sensing electrode;
a second sensing electrode, wherein the first sensing electrode and the second sensing electrode are arranged in a staggered manner and electrically insulated from each other;
a first dummy pattern adjacent to the first sensing electrode and having a first pattern acute angle; and
a second dummy pattern adjacent to the second sensing electrode and having a second pattern acute angle, wherein the first dummy pattern and the second dummy pattern are separated from each other, and the first pattern acute angle and the second pattern acute angle substantially face toward the same overlapped portion between the first sensing electrode and the second sensing electrode.

2. The touch structure according to claim 1, wherein the first sensing electrode has a first electrode side, the second sensing electrode has a second electrode side, the first dummy pattern has a first dummy side, the second dummy pattern has a second dummy side, the first electrode side is substantially parallel to the first dummy side, and the second electrode side is substantially parallel to the second dummy side.

3. The touch structure according to claim 1, wherein the first dummy pattern and the second dummy pattern comprise a triangle shape or a quadrilateral shape.

4. The touch structure according to claim 1, wherein the first sensing electrode comprises a first electrode pattern portion and a first electrode bridge portion coupled to the first electrode pattern portion, the second sensing electrode comprises a second electrode pattern portion and a second electrode bridge portion coupled to the second electrode pattern portion, and the first sensing electrode and the second sensing electrode are arranged in the staggered manner through the first electrode bridge portion and the second electrode bridge portion.

5. The touch structure according to claim 4, wherein the first electrode pattern portion and the second electrode pattern portion respectively have a hexagon shape.

6. The touch structure according to claim 4, wherein the first electrode pattern portion has a first electrode side and a third electrode side adjoined to each other, the third electrode side is adjoined to the first electrode bridge portion,
the second electrode pattern portion has a second electrode side and a fourth electrode side adjoined to each other, the fourth electrode side is adjoined to the second electrode bridge portion,
the first dummy pattern has a first dummy side and a third dummy side adjoined to the first dummy side, the first dummy side is substantially parallel to the first electrode side, the third dummy side is substantially parallel to the third electrode side, and the first pattern acute angle is included between the first dummy side and the third dummy side,
the second dummy pattern has a second dummy side and a fourth dummy side adjoined to the second dummy side, the second dummy side is substantially parallel to the second electrode side, the fourth dummy side is substantially parallel to the fourth electrode side, and the second pattern acute angle is included between the second dummy side and the fourth dummy side.

7. The touch structure according to claim 1, wherein the first sensing electrode has a first electrode side, the second sensing electrode has a second electrode side, the first dummy pattern and the second dummy pattern respectively have a triangle shape or a quadrilateral shape and have a short side and a long side adjoined to the short side, the long side of the first dummy pattern is adjacent and substantially parallel to the first electrode side, the long side of the second dummy pattern is adjacent and substantially parallel to the second electrode side, and the short side of the first dummy pattern is adjacent and substantially parallel to the short side of the second dummy pattern.

8. The touch structure according to claim 7, wherein
the first sensing electrode comprises a first electrode pattern portion and a first electrode bridge portion coupled to the first electrode pattern portion, the first electrode pattern portion has a hexagon shape and has the first electrode side and a third electrode side adjoined to the first electrode side, and the short side of the first dummy pattern is substantially parallel to the third electrode side,
the second sensing electrode comprises a second electrode pattern portion and a second electrode bridge portion coupled to the second electrode pattern portion, the second electrode pattern portion has a hexagon shape and has the second electrode side and a fourth electrode side adjoined to the second electrode side and the second electrode bridge portion, and the short side of the second dummy pattern is substantially parallel to the fourth electrode side,
the first sensing electrode and the second sensing electrode are arranged in a staggered manner through the first electrode bridge portion and the second electrode bridge portion.

9. The touch structure according to claim 8, wherein a length of the first electrode side is larger than a length of the third electrode side, and a length of the second electrode side is larger than a length of the fourth electrode side.

10. The touch structure according to claim 1, further comprising a rectangular dummy pattern adjacent to the first dummy pattern or the second dummy pattern.

11. The touch structure according to claim 10, wherein the first dummy pattern is closer to the first sensing electrode than the rectangular dummy pattern, and the second dummy pattern is closer to the second sensing electrode than the rectangular dummy pattern.

12. The touch structure according to claim 1, further comprising a third dummy pattern having a fifth dummy side, a seventh dummy side and a third pattern acute angle, wherein the third pattern acute angle is included between the fifth dummy side and the seventh dummy side.

13. The touch structure according to claim 12, wherein the first sensing electrode has a first electrode side substantially parallel to the fifth dummy side.

14. The touch structure according to claim 13, comprising a plurality of the first dummy patterns, wherein the third dummy pattern is disposed among the first dummy patterns.

15. The touch structure according to claim 12, further comprising a fourth dummy pattern having a sixth dummy side, an eighth dummy side and a fourth pattern acute angle included between the sixth dummy side and the eighth dummy side.

16. The touch structure according to claim 15, wherein the second sensing electrode has a second electrode side substantially parallel to the sixth dummy side.

17. The touch structure according to claim 1, comprising a plurality of the first dummy patterns, wherein a portion of the first dummy patterns are triangular dummy patterns, the other portion of the first dummy patterns are quadrilateral dummy patterns, and the quadrilateral dummy patterns are closer to the first sensing electrode than the triangular dummy patterns.
